(19) United States
(12) Patent Application Publication
(10) Pub. No.: US 2002/0095294 A1
(43) Pub. Date: Jul. 18, 2002

(54) Voice user interface for controlling a consumer media data storage and playback device

(76) Inventors: Rick Korfin, San Diego, CA (US); Mike Sandler, San Diego, CA (US)

Correspondence Address: COUDERT BROTHERS LLP, 333 SOUTH HOPE STREET, 23RD FLOOR, LOS ANGELES, CA, 90071, US

(21) Appl. No.: 09/760,342

(22) Filed: Jan. 12, 2001

(51) Int. Cl. G10L 11/00

(52) U.S. Cl. 704/275

(57) ABSTRACT

The present invention provides a method for interfacing a voice command to control a consumer media data storage and playback device, and is described in conjunction with one or more specific embodiments. The present invention accepts voice commands either over a microphone that is built in to the device, connected to it by a cable, or built into a wireless remote control, or over a phone line connected to the device. These voice commands can take the form of a complex natural language sentence, a single word, or a short phrase. The device parses all complex natural language sentences before executing them. If the device feels that it needs more information to comply with the voice command, it requests additional information by way of sound effects, computer generated speech, or displaying a graphical menu on a screen, if one is available. Alternately, if the device cannot recognize a voice command, it gives the user a list of appropriate commands. This list is once again given in the form of sound effects, computer generated speech, or displayed as a graphical menu on a screen, if one is available. The user can ask the device for help on a particular command, and the device complies with the request by giving a list of command options. This list is once again given in one of the 3 forms, viz.: sound effects, computer generated speech, or graphical display on a screen, if one is available.

### BACKGROUND OF THE INVENTION

1. Field of the Invention

The present invention relates primarily to the field of home electronic entertainment, and in particular to a method and apparatus for a voice user interface for controlling a consumer media data storage and playback device.

Portions of the disclosure of this patent document contains material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Home electronic entertainment systems have rapidly advanced in recent years. First came the radio, which was followed closely by the television. The television has itself advanced from black and white transmission, to color transmission, to the recent digital transmission. After the popularity of the television came other forms of home entertainment systems which include the cassette tape player/recorder, the compact disc player/recorder, the video cassette player/recorder (VCP/VCR), and more recently the digital video disc player/recorder (DVD-P/DVD-R). Simultaneously, the Internet has grown immensely and has become the favorite medium for users to not only be entertained, but also shop, learn, and communicate with others via e-mail or other means, such as news groups and chat-rooms.

All of these devices require user interaction to either play, record, or perform other user commands. User interactions are usually physical, while device interactions are usually graphical. In the case of the radio, the user can physically pre-set a certain number of radio stations which can be played back at the touch of a button. The setting of these stations is done physically by turning a dial, or pressing a set of buttons. The system may respond back by displaying the set stations on a light emitting diode (LED) screen. Other information such as time, channel number, volume, bass, treble, and balance levels may also be simultaneously displayed graphically on the LED screen.

In the case of a VCR or DVD-R, the user can issue a command of play or record (which include timer recording) by the touch of buttons, and the requested command is displayed graphically on a screen. The system may also respond by graphically displaying an arrow indicating the direction of play or record, the channel being played or recorded, a time counter, speed of play or record, etc. In the case of timer recording, the user keys in via the remote control the date, time, and duration of the program, as well as the channel of broadcast, and the recording speed. Most contemporary VCRs allow multiple programs to be preset recorded, commonly known as timer recording, as long as the dates and times of these programs do not coincide. The system responds by displaying all this information graphically when prompted or at the time of execution.

The Internet can be accessed by not only a desktop or laptop computer, but also by a cellular phone, Personal Digital Assistant (PDA), and other commercial products like WebTV™. All of these devices display some kind of graphical user interface (GUI) to navigate the user through the Internet. Since television service companies like DirectTV™ are now offering its services to access the Internet, the user does not need a computer with a processor to be able to access the Internet. WebTV™ offers not only access to email and the Internet via a television set, but it also allows the user to view regular TV programs. Commercial services like Tivo™ and ReplayTV™ need only a set-top box and a television set to not only find and record a TV show, but can perform such tasks as instant replay, slow down the action for a closer look, or digitally rewind a show to view it again.

Set-top Box

A set-top box is a device that not only looks like a VCR, but is connected to a television set in much the same way. It not only replaces the VCR because it performs a range of functions including all VCR functions like play, record, rewind, forward, etc., but it also eliminates the need for a video cassette to record any program. The user can, for instance, record a favorite show for the entire season, even if the network later changes the show's timeslot. It can also pause a live TV program and restart it at the user's convenience. There is a storage mechanism in the set-top box that digitally records the live show and plays it back when the pause button is released. This feature allows the user to not miss any sections of a show due to interruptions like phone calls.

It also performs live instant replays of a TV show, plays the show in slow motion, or frame-by-frame advances the show. Since all these features are performed digitally, there is no fuzziness, blurring, or horizontal lines to mar the image. These features can be performed via a remote control that works the same way as the remote control of a TV or VCR. The user clicks a few buttons to perform a task with the help of a GUI which is screened on the TV set. The set-top box not only displays on the TV screen a list of exclusive programs recorded just for a user, but can also display a list of shows that match a user's interest. If the user wishes to record a show in the listing, he/she has to highlight the show by way of the remote control, and press the record button once to automatically record the show at the given time, or press the record button twice to record the show every time it is on. Even though the GUI walks a user through the various features, it still requires the user to not only be physically present to perform these functions, but also physically interact with the device by way of clicking buttons or pushing knobs.

Limitations of Prior Art Systems

In all the devices mentioned above, there is a combination of physical and/or graphical interface to achieve the task of navigating through the labyrinth of the Internet via a computer or a set-top box, listening to the radio, viewing a program on television, viewing or recording a movie on a VCR or DVD-R, or recording a TV show via a set-top box. Because of this graphical interface, the user has to interact with the device by either selecting a given option with the help of a pointing device like a mouse, or by physically turning a dial or pushing a button. Hence, it requires the physical presence of the user in front of the home electronic entertainment system to achieve the task. There is no capability of the user accessing the device via some remote means like a telephone. Also because of this graphical interaction between the user and the device, the buttons on a remote control, keyboard, or cellular phone have dual functionality. For example, the number buttons on a touch-tone telephone can double as inputting a name in the directory, where successive push of the “2” button can be used for a “a”, “b”, or “c”. The “*” button can be used to capitalize the letters, whereas the “#” button can be used to leave a space between characters. All of this can get very confusing, especially since the user may not have an operating manual handy at all times.

This limitation of physical and graphical user interactions with present devices is also a big handicap for the blind, and other physically handicapped people because it requires them to turn knobs, press buttons, and view all instructions graphically. In case of a blind person using the radio to listen to music on a certain station, the person will not know the station chosen until the station revels itself in an advertisement or promotion. In case of a physically handicapped person using the television and VCR or DVD-R to record a certain program, the person may not be able to physically push buttons or turn knobs on a remote control to get the setting.

### SUMMARY OF THE INVENTION

The present invention is directed to a voice user interface that controls a consumer media data storage and playback device. In one embodiment, the invention is a consumer electronics product that supplements or replaces a more traditional on-screen GUI controlled through a remote control device (wire or wireless) with a speech user interface controlled by commands spoken into a microphone.

In another embodiment, the device may confirm a verbal command of the user or request additional information by way of audio prompts. In yet another embodiment where the device has a phone line connection, the user could use a remote device such as a telephone to “call” the device and give it verbal commands.

In another embodiment, the invention greatly simplifies the interaction required by a user to control the device. In yet another embodiment, the invention simplifies the prior art complexities of on-screen menus and complex remote control commands into a simple verbal command made by the user, or a simple verbal dialog between the user and the device.

In another embodiment, the invention allows the user to give a verbal command by complex natural language sentences, by single words, or by short phrases. In the case where complex natural language sentences are spoken, the device parses the command before executing it. In another embodiment, the device also accepts spoken conversational dialog between the user and itself using the Automatic Speech Recognition (ASR) and Text-To-Speech (TTS) technologies available on the device. In yet another embodiment, if the user needs help with the kinds of commands recognizable by the device, the device graphically displays those commands on a screen, if a screen is available.

In one embodiment, the voice user interface (VUI) controls one or more nodes in a multi-node entertainment system architecture. In this architecture, one or more nodes act as clients and one node acts as both a client and a server in a client/server architecture.

These nodes may connect to a television set to receive television signals, to the Internet, act as video playback and recording devices using DVD-R, for instance, and may be used as radios or audio jukeboxes, for instance, by playing an audio file downloaded from the Internet.

### BRIEF DESCRIPTION OF THE DRAWINGS

These and other features, aspects and advantages of the present invention will become better understood with regard to the following description, appended claims and accompanying drawings where:

FIG. 1 is a flowchart that shows a VUI.

FIG. 2 shows two categories of voice commands.

FIG. 3 is a flowchart that shows the operation of a VUI according to an embodiment of the present invention.

FIG. 4 is a flowchart that shows another operation of a VUI according to an embodiment of the present invention.

FIG. 5 is a flowchart that shows yet another operation of a VUI according to an embodiment of the present invention.

FIG. 6 is a flowchart that shows by example the operation of a VUI according to an embodiment of the present invention.

FIG. 7 is a flowchart that shows by example another operation of a VUI according to an embodiment of the present invention.

FIG. 8 is a flowchart that shows by example yet another operation of a VUI according to an embodiment of the present invention.

FIG. 9 is an illustration of an embodiment of a computer execution environment.

### DETAILED DESCRIPTION OF THE INVENTION

The invention is a method and apparatus for voice user interface to control a consumer media data storage and playback device. In the following description, numerous specific details are set forth to provide a more thorough description of the embodiments of the invention. It is apparent, however, to one skilled in the art, that the invention may be practiced without these specific details. In other instances, well known features have not been described in detail so as not to obscure the invention.

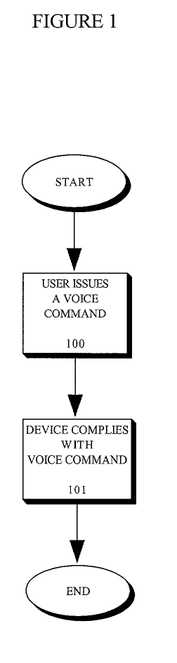

The invention greatly reduces complex interactions required by a user to control a media data storage and playback device. In one embodiment it accomplishes this by eliminating prior art complex GUI with a simple VUI. FIG. 1 shows a flowchart that illustrates this interface, where at step 100 a user issues a voice command to the device. Then, at step 101, the device complies with the voice command.

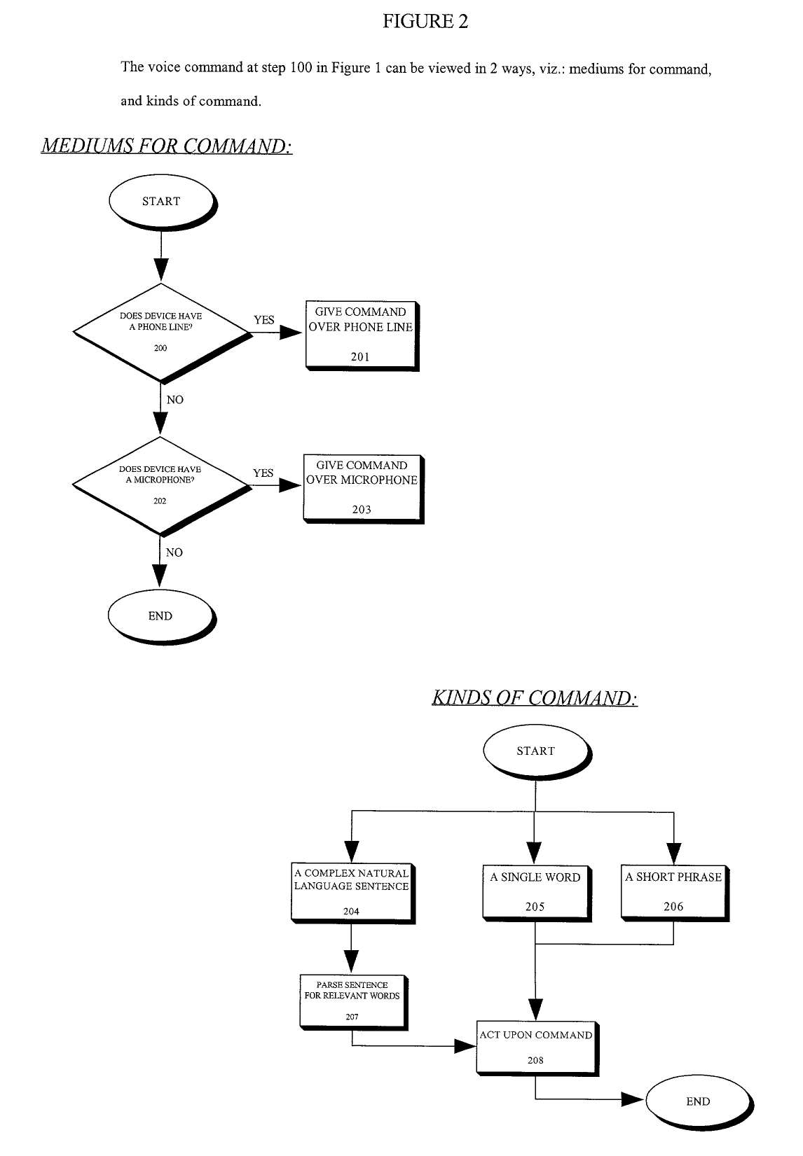

Since a user can control the device with the help of a verbal command, this command can be given in several ways to the device. The command can either be spoken into a microphone either built into the body of the device, or wired to it with a cable, or can be spoken into a wireless microphone, such as one built into an infrared remote control. In case of a command spoken into a wireless microphone, the ASR technology which is housed in the remote control converts the spoken command to an infrared command that is transferred from the remote control to the device. Alternately, if the device has a phone line connection, a verbal command can be given by calling in to the device using a conventional telephone. FIG. 2 shows an illustration of this embodiment, where at step 200 if the device has a phone line, then at step 201 the voice command is given over the phone line. If the device does not have a phone line, but has a microphone instead, as seen at step 202, then at step 203 the voice command is given over the microphone.

A verbal command can take the form of a single word, a short phrase, or a complex natural language sentence. Alternately, the device can also recognize human speech using the built-in ASR technology. If the command is a complex natural language sentence, the device has the capability of parsing the sentence before executing it. FIG. 2 also shows how this voice command may take the form of these 3 different kinds of commands. At step 204, the voice command is in the form of a complex natural language sentence, at step 205, it is in the form of a single word, and at step 206, it is in the form of a short phrase. If the command is a complex natural language sentence, then at step 207 it is parsed. Finally, at step 208 this command, irrespective of its form, is acted upon by the device.

Additional Information

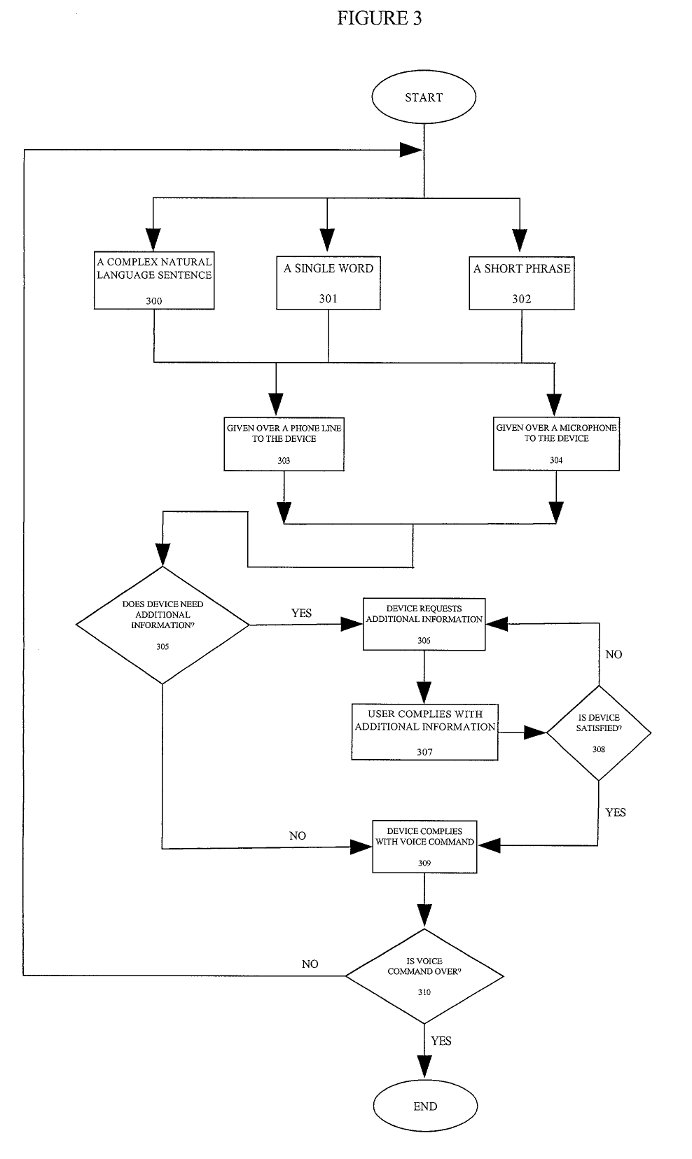

When using a VUI, the user may forget to give all of the input needed to complete a given command. This leads to a situation where the VUI will require additional information in order to complete the command. In another embodiment, the present invention not only solves the problem of requesting this additional information, but also of how this additional information is requested. FIG. 3 is an illustration of how it accomplishes these two tasks, where at steps 300 to 302 a verbal command can take one of the three forms discussed in FIG. 2 above. At steps 303 and 304 this command is either given via a phone line or a microphone attached to the device. At step 306, if the device needs more information to fulfill the command, then at step 307 it requests additional information.

One embodiment of the invention allows the device to ask for this information either by communicating verbally with the user by way of computer speech using ASR technology, or by displaying the information on a screen, if one is available. At step 307 the user complies with this additional information. If at step 308 the device is satisfied with the information supplied by the user, it complies with the voice command at step 310, else it requests for more information once again (step 306). This closed loop continues until the device has all the information to comply with the voice command at step 309. Alternately, if the device does not need additional information at step 305, it complies with the voice command at step 309. If at step 310 the voice command is not over, the VUI allows the user to give it the next command by taking the user back to steps 300 through 302.

Incorrect or Incomplete command

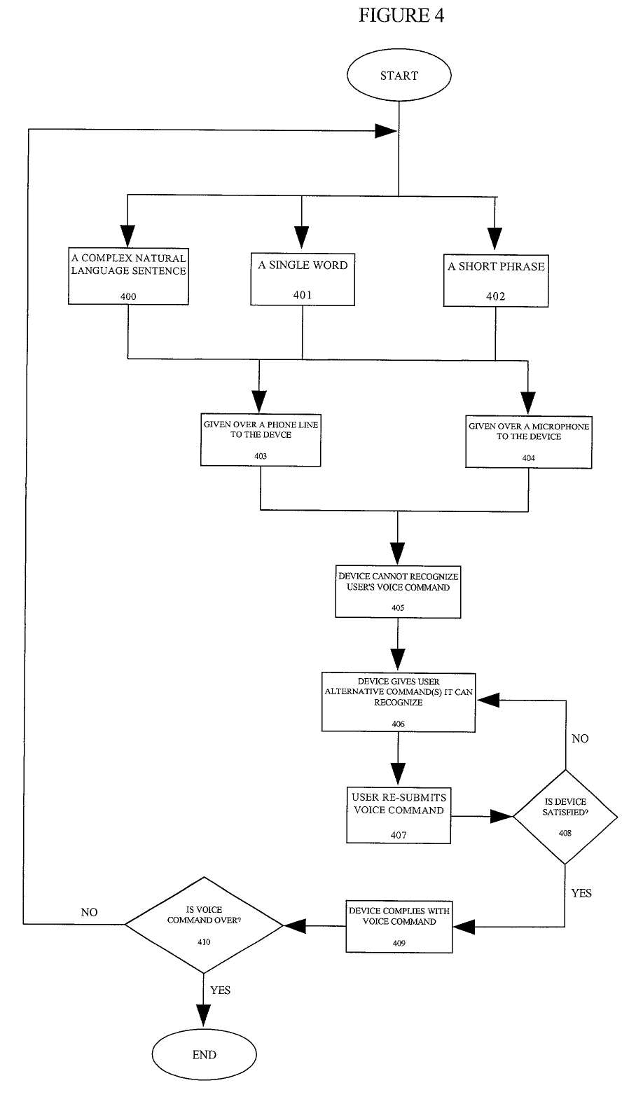

When using a VUI, the voice command may be incorrect simply because the device cannot understand the accent of the user, or the user is suffering from laryngitis and cannot speak loudly and clearly, or the user is using words that do not have an universally accepted meaning. On the other hand, the user may forget to give all the input needed to fulfill a command in which case the VUI considers the command incomplete. FIG. 4 shows a flowchart which illustrates one embodiment of the invention to reduce user controls of the device by recognizing an incorrect or incomplete voice command. Steps 400 through 402 shows the different forms of a voice command as seen in FIG. 2 above. At steps 403 and 404 this voice command is either given over a phone line or a microphone attached to the device. At step 405 if this command is not understood by the device because it is incorrect or incomplete, it recognizes the fault, and at step 406 gives the user a list of alternate command(s) it can recognize and accept.

At step 407, the user chooses an appropriate command from the list and re-submits the voice command. At step 408 if the device is satisfied, then at step 409 it complies with the command, else the device once again gives the user the list of alternate command(s) as seen at step 406. This closed loop continues until the device is satisfied with the correct command. If at step 410 the voice command is not over, the VUI allows the user to give it the next command by taking the user back to steps 400 through 402.

Help with Commands

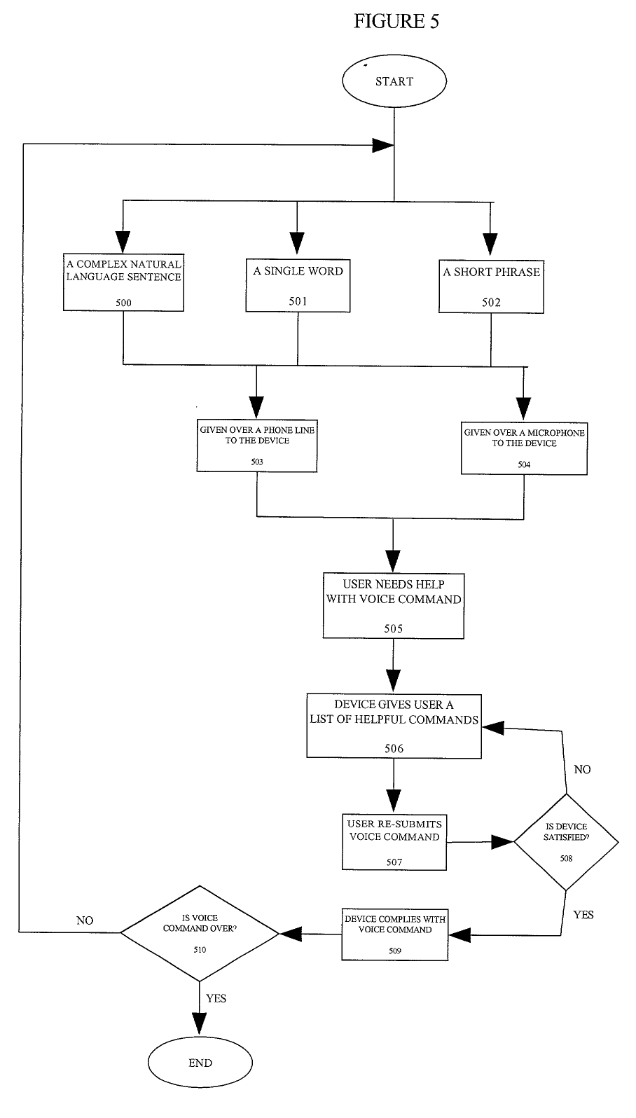

When using a VUI, the user may forget the correct command or sequence of commands to execute a certain task. If the user has never used a particular command in the past, he/she may want to know the different options and their results, and the VUI should be able to help the user with the queries. FIG. 5 shows a flowchart which illustrates one embodiment of the invention to help the user with a voice command by either having a spoken conversational dialog with the user using ASR technology, or graphically displaying a help menu on a screen, if one is available. Steps 500 through 502 shows the different forms of a voice command as seen in FIG. 2 above. At steps 503 and 504 this voice command is either given over a phone line or a microphone attached to the device. At step 505, if the user needs help with a voice command, then at step 506 the device gives the user a list of helpful commands. At step 507 the user chooses a command and re-submits it. At step 508 if the device is not satisfied with the voice command either because it cannot parse it, or it is inappropriate, it gives the user, once again, a list of helpful commands as seen at step 506. This closed loop is repeated until the device is satisfied and complies with the voice command at step 509. If at step 510 the voice command is not over, the VUI allows the user to give it the next command by taking the user back to steps 500 through 502.

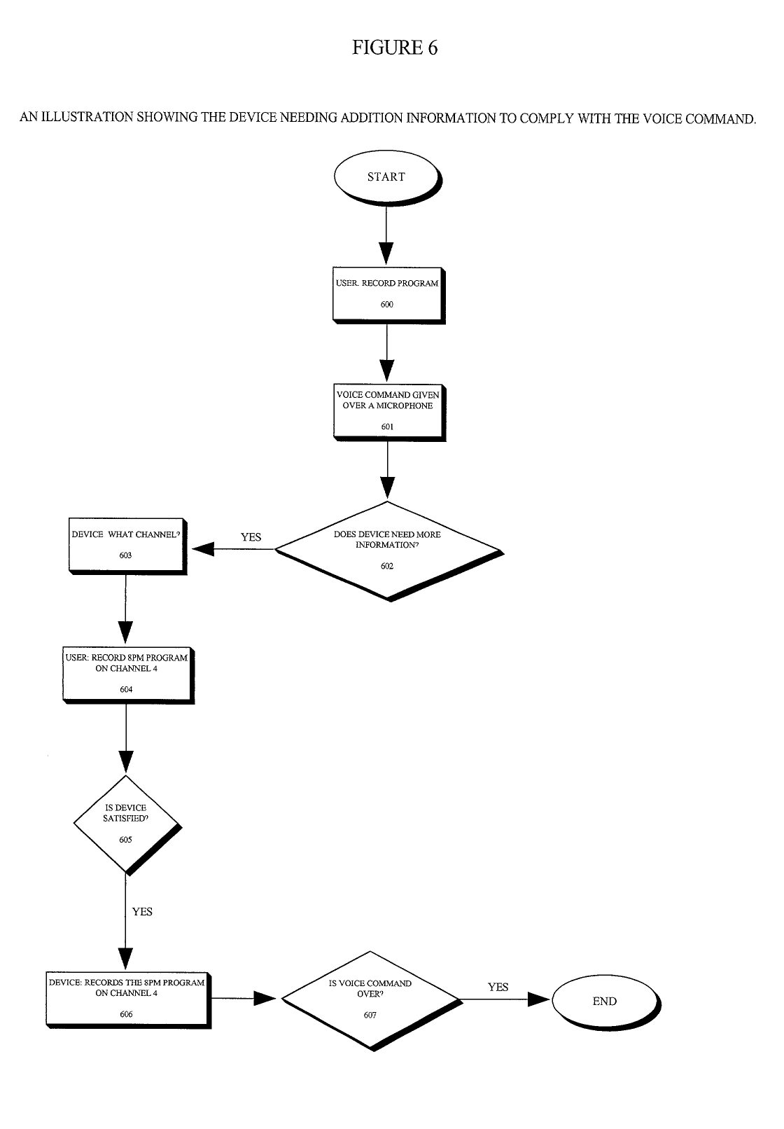

FIGS. 6 through 8 illustrate how FIGS. 3 through 5 are accomplished by way of an example. The example chosen for the illustration is a user asking a device to record a particular program. It is apparent, however, to one skilled in the art, that any other command would yield similar results, and that the example chosen is only an illustration.

Additional Information

FIG. 6 shows a scenario of the device needing additional information to comply with the voice command. At step 600, the user gives a voice command in the form of a short phrase for the device to record a program. This command is given at step 601 over a microphone attached to the device. At step 602, the device needs more information, and asks for it at step 603. At step 604 the user gives this addition information. At step 605, since the device is satisfied, it complies with the voice command at step 606. At step 607, since the user has no further commands, the VUI ends.

Incorrect or Incomplete command

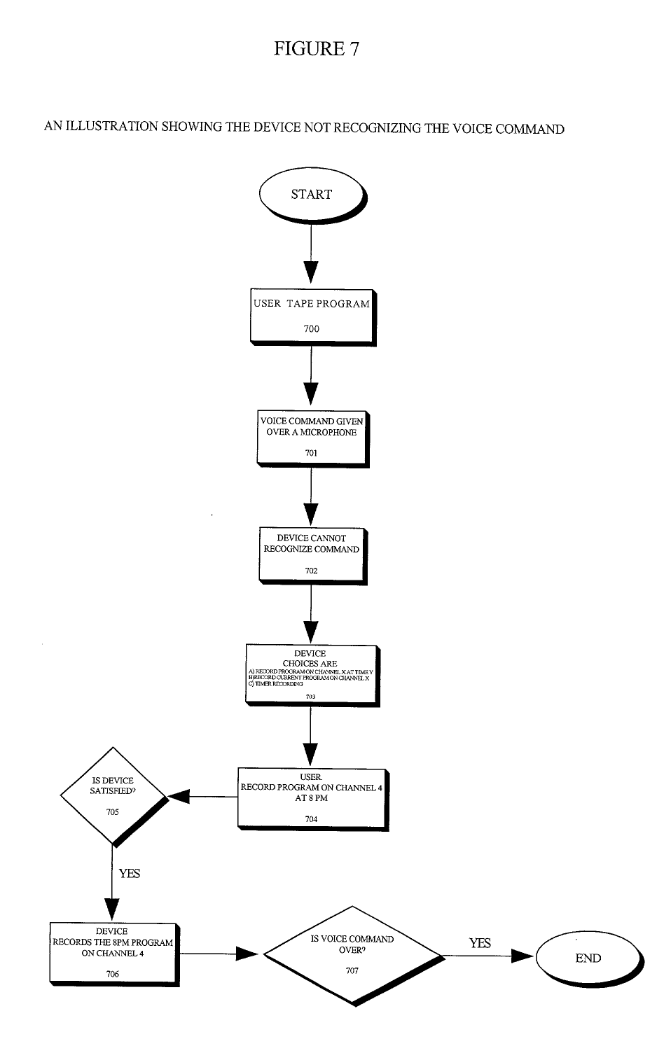

FIG. 7 shows a scenario of the device not recognizing a voice command. At step 700 the user gives the voice command in the form of a short phrase to tape a program. This command is given at step 701 over a microphone attached to the device. At step 702, since the device cannot recognize the voice command, it gives the user at step 703 a list of commands appropriate at that stage. At step 704 the user makes a valid choice from the list. As shown in this example “to tape” and “to record” may mean the same in colloquial English, but have different meanings to a VUI. At step 705, since the device is satisfied, it complies with the voice command at step 706. At step 707, since the user has no further commands, the VUI ends.

Help with Commands

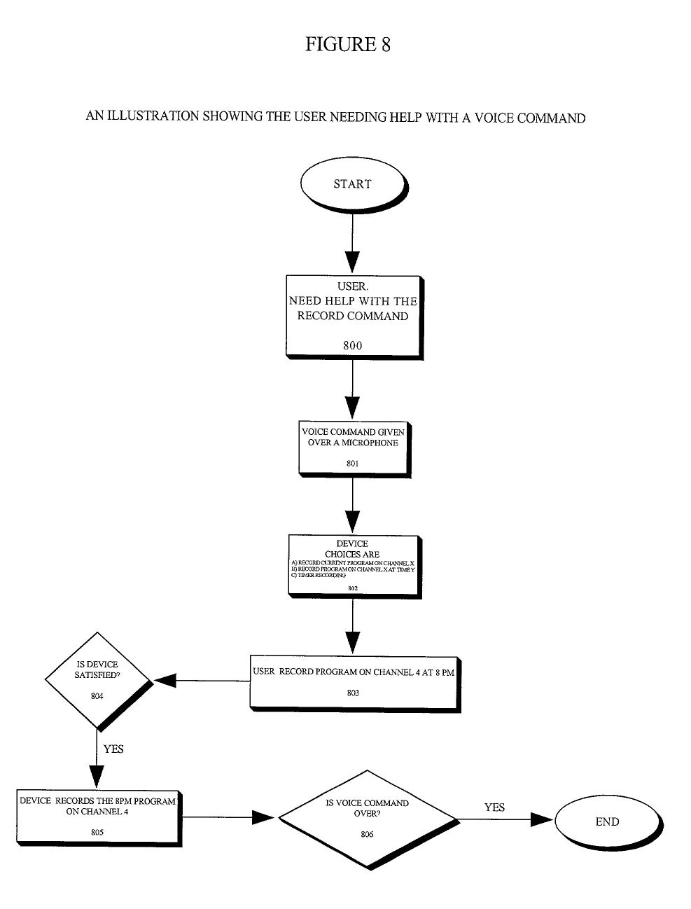

FIG. 8 shows a scenario of the user needing help with a voice command. At step 800 the user gives a voice command in the form of a short phrase for help with the record command. This command is given at step 801 over a microphone attached to the device. At step 802, the device gives the user either in the form of a graphical menu if a screen is available, or by using ASR technology, the choices for the record command. The user, at step 803, makes a choice from the given list. At step 804, since the device is satisfied, it complies with the voice command at step 805. At step 806, since the user has no further commands, the VUI ends.

Multi-node Entertainment System Architecture

The VUI of the present invention can be used to control a multi-node, entertainment system architecture. In this architecture one or more devices are arranged in a client/server architecture. The devices are configured to connect to a television or other output device to receive television signals, to perform the functions of a general purpose computer, to access the Internet, and perform other computer network functions, and to play music, for instance by playing audio files downloaded from the Internet. The above described architecture is described in co-pending U.S. patent application entitled “Multi-Node, Entertainment System Architecture” Ser. No. ______, filed on ______, assigned to the assignee of the present application, and hereby fully incorporated into the present application by reference.

Embodiment of a Computer Execution Environment

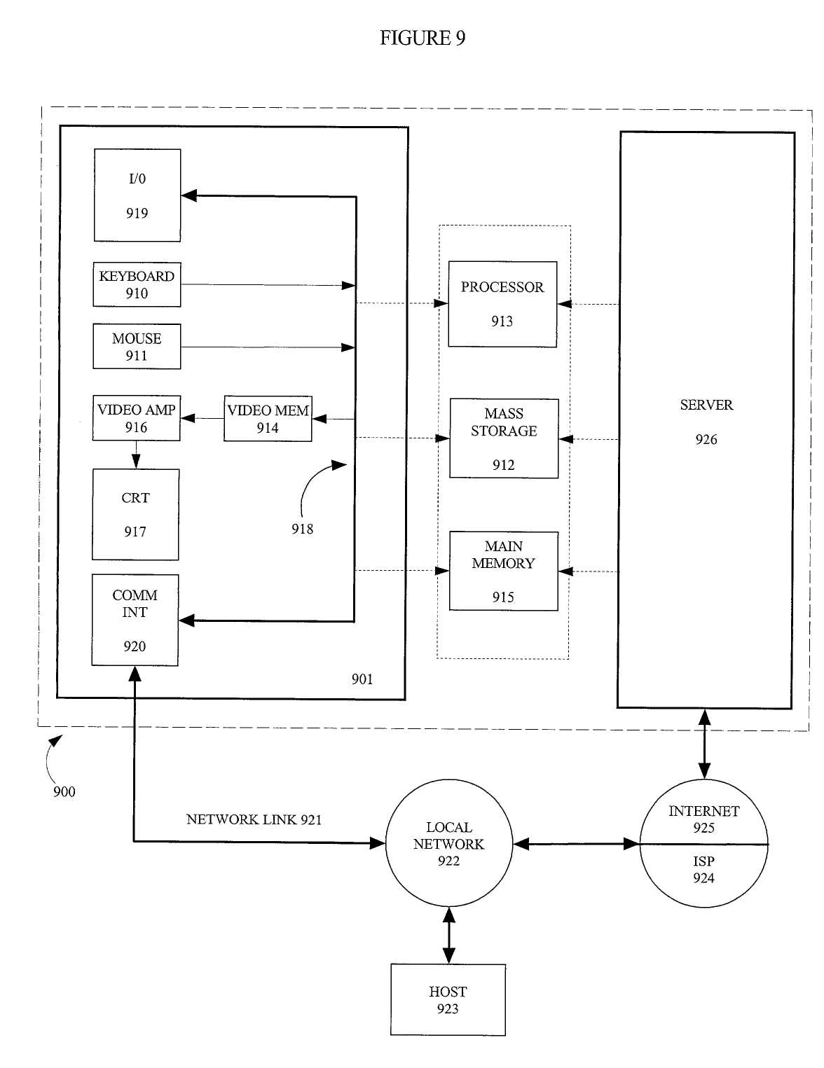

An embodiment of the invention can be implemented as computer software in the form of computer readable code executed in a desktop general purpose computing environment such as environment 900 illustrated in FIG. 9, or in the form of bytecode class files running in such an environment. A keyboard 910 and mouse 911 are coupled to a bi-directional system bus 918. The keyboard and mouse are for introducing user input to a computer 901 and communicating that user input to processor 913.

Computer 901 may also include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 920 provides a data communication connection via network link 921 to a compatible LAN. Wireless links are also possible. In any such implementation, communication interface 920 sends and receives electrical, electromagnetic or optical signals, which carry digital data streams representing various types of information.

Network link 921 typically provides data communication through one or more networks to other data devices. For example, network link 921 may provide a connection through local network 922 to local server computer 923 or to data equipment operated by ISP 924. ISP 924 in turn provides data communication services through the world wide packet data communication network now commonly referred to as the “Internet” 925. Local network 922 and Internet 925 both use electrical, electromagnetic or optical signals, which carry digital data streams. The signals through the various networks and the signals on network link 921 and through communication interface 920, which carry the digital data to and from computer 900, are exemplary forms of carrier waves transporting the information.

Processor 913 may reside wholly on client computer 901 or wholly on server 926 or processor 913 may have its computational power distributed between computer 901 and server 926. In the case where processor 913 resides wholly on server 926, the results of the computations performed by processor 913 are transmitted to computer 901 via Internet 925, Internet Service Provider (ISP) 924, local network 922 and communication interface 920. In this way, computer 901 is able to display the results of the computation to a user in the form of output. Other suitable input devices may be used in addition to, or in place of, the mouse 911 and keyboard 910. I/O (input/output) unit 919 coupled to bi-directional system bus 918 represents such I/O elements as a printer, A/V (audio/video) I/O, etc.

Computer 901 includes a video memory 914, main memory 915 and mass storage 912, all coupled to bi-directional system bus 918 along with keyboard 910, mouse 911 and processor 913.

As with processor 913, in various computing environments, main memory 915 and mass storage 912, can reside wholly on server 926 or computer 901, or they may be distributed between the two. Examples of systems where processor 913, main memory 915, and mass storage 912 are distributed between computer 901 and server 926 include the thin-client computing architecture developed by Sun Microsystems, Inc., the palm pilot computing device, Internet ready cellular phones, and other Internet computing devices.

The mass storage 912 may include both fixed and removable media, such as magnetic, optical or magnetic optical storage systems or any other available mass storage technology. Bus 918 may contain, for example, thirty-two address lines for addressing video memory 914 or main memory 915. The system bus 918 also includes, for example, a 32-bit data bus for transferring data between and among the components, such as processor 913, main memory 915, video memory 914, and mass storage 912. Alternatively, multiplex data/address lines may be used instead of separate data and address lines.

In one embodiment of the invention, the processor 913 is a microprocessor manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and may be implemented by any suitable apparatus. This circuitry converts pixel data stored in video memory 914 to a raster signal suitable for use by monitor 917. Monitor 917 is a type of monitor suitable for displaying graphic images.

Computer 901 can send messages and receive data, including program code, through the network(s), network link 921, and communication interface 920. In the Internet example, remote server computer 926 might transmit a requested code for an application program through Internet 925, ISP 924, local network 922 and communication interface 920. The received code may be executed by processor 913 as it is received, and/or stored in mass storage 912, or other non-volatile storage for later execution. In this manner, computer 900 may obtain application code in the form of a carrier wave. Alternatively, remote server computer 926 may execute applications using processor 913, and utilize mass storage 912, and/or video memory 915. The results of the execution at server 926 are then transmitted through Internet 925, ISP 924, local network 922, and communication interface 920. In this example, computer 901 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for voice user interface for controlling a consumer media data storage and playback device is described in conjunction with one or more specific embodiments. The invention is defined by the following claims and their full scope of equivalents.

1. A method for inputting a voice command to control a consumer digital media storage and playback device comprising:
issuing said voice command; and
complying with said voice command by said media data storage and playback device.

2. The method of claim 1 wherein said step of issuing is given over a microphone.

3. The method of claim 2 wherein said microphone is attached to the device by means of a cable.

4. The method of claim 2 wherein said microphone is built in to the device.

5. The method of claim 2 wherein said microphone is built in to a wireless remote control.

6. The method of claim 1 wherein said step of issuing is given over a phone line.

7. The method of claim 1 wherein said voice command is a complex natural language sentence.

8. The method of claim 7 wherein said complex natural language sentence is parsed before execution.

9. The method of claim 1 wherein said voice command is a single word.

10. The method of claim 1 wherein said voice command is a short phrase.

11. The method of claim 1 wherein said voice command given is parsed with ASR technology.

12. The method of claim 1 wherein said step of complying further comprises:
confirming said voice command with an audio prompt;
requesting additional information, if necessary; and
giving help with commands.

13. The method of claim 12 wherein said step of confirming is in the form of sound effects.

14. The method of claim 12 wherein said step of confirming is in the form of a computer generated speech.

15. The method of claim 12 wherein said step of requesting is in the form of a computer generated speech.

16. The method of claim 12 wherein said step of requesting is displayed graphically on a screen, if one is available.

17. The method of claim 12 wherein said step of giving help is in the form of a computer generated speech.

18. The method of claim 12 wherein said step of giving help is displayed graphically on a screen, if one is available.

19. A computer program product comprising:
a computer usable medium having computer readable program code embodied therein configured to inputting a voice command to control a consumer media data storage and playback device, said computer product comprising:
computer readable code configured to cause a computer to issue said voice command; and
computer readable code configured to cause a computer to comply with said voice command by said media data storage and playback device.

20. The computer program product of claim 19 wherein said computer readable program code configured to issue said voice command is given over a microphone.

21. The computer program product of claim 20 wherein said computer readable program code configured to issue said voice command given over said microphone is attached to the device by means of a cable.

22. The computer program product of claim 20 wherein said computer readable program code configured to issue said voice command given over said microphone is built in to the device.

23. The computer program product of claim 20 wherein said computer readable program code configured to issue said voice command given over said microphone is built in to a wireless remote control.

24. The computer program product of claim 19 wherein said computer readable program code configured to issue said voice command is given over a phone line.

25. The computer program product of claim 19 wherein said computer readable program code configured to issue said voice command is a complex natural language sentence.

26. The computer program product of claim 25 wherein said computer readable program code configured to issue said complex natural language sentence is parsed before execution.

27. The computer program product of claim 19 wherein said computer readable program code configured to issue said voice command is a single word.

28. The computer program product of claim 19 wherein said computer readable program code configured to issue said voice command is a short phrase.

29. The computer program product of claim 19 wherein said computer readable program code configured to issue said voice command is given parsed with technology.

30. The computer program product of claim 19 wherein said computer readable program code configured to cause a computer to comply with said voice command by said media data storage and playback device further comprises:
to confirm said voice command with an audio prompt;
to request additional information, if necessary; and
to give help with commands.

31. The computer program product of claim 30 wherein said computer readable program code configured to cause a computer to confirm said voice command with an audio prompt is in the form of sound effects.

32. The computer program product of claim 30 wherein said computer readable program code configured to cause a computer to confirm said voice command with an audio prompt is in the form of a computer generated speech.

33. The computer program product of claim 30 wherein said computer readable program code configured to cause a computer to request additional information is in the form of a computer generated speech.

34. The computer program product of claim 30 wherein said computer readable program code configured to cause a computer to request additional information is displayed graphically on a screen, if one is available .

35. The computer program product of claim 30 wherein said computer readable program code configured to cause a computer to give help is in the form of a computer generated speech.

36. The computer program product of claim 30 wherein said computer readable program code configured to cause a computer to give help is displayed graphically on a screen, if one is available.
